(19) United States
(12) Patent Application Publication
(10) Pub. No.: US 2025/0116998 A1
(43) Pub. Date: Apr. 10, 2025

(54) MACHINE MANAGEMENT METHOD AND MACHINE ARRANGEMENT

(71) Applicant: TRUMPF Werkzeugmaschinen SE + Co. KG, Ditzingen (DE)

(72) Inventors: Korbinian Weiß, Korntal (DE); Willi Pönitz, Leonberg (DE); Marc Teschner, Stuttgart (DE); Jens Ottnad, Karlsruhe (DE)

(21) Appl. No.: 18/986,842

(22) Filed: Dec. 19, 2024

Related U.S. Application Data
(63) Continuation of application No. PCT/EP2023/064996, filed on Jun. 5, 2023.

(30) Foreign Application Priority Data
Jun. 28, 2022 (DE) 10 2022 115 996.5

(51) Int. Cl. G05B 19/418

(52) U.S. Cl. CPC G05B 19/41865; G05B 2219/32335; G05B 2219/32423

(57) ABSTRACT

A machine management method for performing planned activities on a machine is provided. Workpieces are manufactured by the machine according to a predetermined schedule during a respective planned activity of the machine. Manufactured workpieces are sorted from a removal area of the machine into a deposition area during a further respective planned activity of the machine according to the predetermined schedule. The method includes determining a manufacturing time for the workpieces by a machine management system based on manufacturing process data of the machine, determining a removal time for sorting the workpieces by the machine management system based on removal process data, changing the predetermined schedule to obtain a changed schedule for the planned activities by the machine management system based on a comparison of the manufacturing time with the removal time, and transferring the changed schedule to a controller of the machine.

### CROSS REFERENCE TO RELATED APPLICATIONS

This application is a continuation of International Application No. PCT/EP2023/064996 (WO 2024/002626 A1), filed on Jun. 5, 2023, and claims benefit to German Patent Application No. DE 10 2022 115 996.5, filed on Jun. 28, 2022. The aforementioned applications are hereby incorporated by reference herein.

### FIELD

Embodiments of the present invention relate to a machine management method for performing activities on a machine, wherein workpieces are manufactured by a machining apparatus according to a predetermined schedule during a planned activity of the machine and manufactured workpieces are sorted from a removal area of the machine into a deposition area of the removal device during a further planned activity of the machine according to the predetermined schedule. Embodiments of the present invention further relate to a machine arrangement having a machine management system for performing such a machine management method.

### BACKGROUND

Downtime and machine failures usually result in significant financial and productivity losses. Therefore, the machines are typically operated with predetermined schedules to reduce time losses due to manual operation and increase the level of automation.

Typically, the predetermined schedules are closely timed and optimized with regard to the desired productivity of the respective machine in order to prevent downtime. As a result, important condition-maintaining activities such as maintenance, cleaning, diagnostics and/or calibration activities on the machines are often not adequately taken into account, which increases the risk of machine failure and/or inadequate manufacturing quality. In addition, even with predetermined schedules, unavoidable machine downtimes occur if, for example, raw materials have to be prepared for manufacturing or manufactured workpieces have to be removed from the machine.

Furthermore, predetermined schedules only allow for an inadequate prediction of the actual course of machine operation. For example, unforeseen circumstances, malfunctions, or necessary maintenance or diagnostic measures can lead to unplanned downtimes that require a complex change to the schedule. During reorganization, the condition-maintaining activities are often eliminated from the changed sequence in favor of higher machine productivity.

Prior art of a different kind is known from DE 10 2013 217 911 A1, which describes a tool head with an integrated operating data acquisition device. An operational data acquisition device records data to plan maintenance intervals for the tool head. The downtime can thus be saved.

### SUMMARY

Embodiments of the present invention provide a machine management method for performing planned activities on a machine. Workpieces are manufactured by the machine according to a predetermined schedule during a respective planned activity of the machine. Manufactured workpieces are sorted from a removal area of the machine into a deposition area during a further respective planned activity of the machine according to the predetermined schedule. The method includes determining a manufacturing time for the workpieces by a machine management system based on manufacturing process data of the machine, determining a removal time for sorting the workpieces by the machine management system based on removal process data, changing the predetermined schedule to obtain a changed schedule for the planned activities by the machine management system based on a comparison of the manufacturing time with the removal time, and transferring the changed schedule to a controller of the machine.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a machine arrangement according to embodiments of the invention with a machine and a machine management system in a perspective view;

FIG. 2 shows the method according to embodiments of the invention in a schematic flow chart;

FIG. 3 shows an exemplary predetermined schedule for a machine with planned activities in a schematic representation, according to some embodiments;

FIG. 4 shows an actual sequence of planned activities on a machine in a schematic representation, according to some embodiments;

FIG. 5 shows a schematic representation of a first exemplary changed schedule with unplanned activities added by a machine management system, according to some embodiments;

FIG. 6 shows a schematic representation of a second exemplary changed schedule with temporally shifted planned activities and an added unplanned activity, according to some embodiments; and

FIG. 7 shows a schematic representation of a third exemplary changed schedule with partial schedules of two machines, wherein a planned activity from one machine is transferred to the other machine, according to some embodiments.

### DETAILED DESCRIPTION

Embodiments of the invention provide a method and a device by which downtimes can be avoided and productivity is kept at a high level.

Embodiments of the present invention provide a machine management method for performing planned activities on a machine, wherein workpieces are manufactured by a machining apparatus according to a predetermined schedule during a planned activity of the machine and manufactured workpieces are sorted from a removal area of the machine into a deposition area during a further planned activity of the machine according to the predetermined schedule,

wherein a manufacturing time for the workpieces is predetermined by a machine management system on the basis of manufacturing process data of the machining apparatus, and a removal time for sorting the workpieces is predetermined by the machine management system on the basis of removal process data, and

wherein the schedule for the planned activities is changed by the machine management system on the basis of a comparison of the manufacturing time with the removal time and is transferred to a controller of the machine.

The method according to embodiments of the invention thus provides for the predetermination of the start time, end time and duration of the activities of the machine, whereby the actual machine sequence can be determined more precisely. The predetermination may show deviations from the planned sequence by comparison with the predetermined sequence. The deviations may occur in the form of downtime of the machine, or at least of subcomponents of the machine, and can then be used to improve productivity, manufacturing quality and/or machine condition by changing the schedule.

In contrast to conventional machine management methods, machine process data is used to predict the manufacturing time and the removal time. This allows the machine management system to predict the manufacturing time and the removal time much more accurately.

In addition, it may be provided that a loading time for loading the machine with a raw material is taken into account when comparing the manufacturing time with the removal time. To predict the loading time, the machine's loading time process data can be used.

A planned activity is understood to be an activity to be performed by the machine as defined in the predetermined schedule. A planned activity typically consists of performing value-added activities, such as the manufacturing of workpieces and/or the removal of workpieces. In addition, non-value-adding activities, such as condition-maintaining activities such as maintenance, diagnostics, cleaning and/or calibration activities, can also be planned.

The removal process data, the loading process data and the manufacturing process data typically originate from the machine, the actual sequence of which is to be predetermined by the machine management system. The removal process data, the loading process data and/or the manufacturing process data can, for example, be recorded manually and/or stored in the machine and/or the machine management system.

The finished workpieces can be removed from the machine manually or by hand by an operator. Preferably, the finished workpieces are sorted by a removal device. The finished workpieces can be removed from a removal area of the machine and placed in a deposition area of the removal device. This allows the level of automation of the machine to be further increased.

In a preferred embodiment of the machine management method, it is provided that the manufacturing of the workpieces by the machining apparatus takes place at the same time as the removal of the manufactured workpieces, in particular by the removal device. For this purpose, the manufactured workpieces are preferably transferred from the machining area of the machining apparatus to a spatially distanced removal area of the machining apparatus. The freed-up machining area can then be occupied by a new panel or raw material from which the workpieces are manufactured. This enables the parallel sorting of already manufactured workpieces while further workpieces are being manufactured. This can significantly increase productivity compared to a sequential method.

Furthermore, in a preferred further development of the machine management method the schedule is changed by adapting the manufacturing time of the machining apparatus to the removal time, in particular of the removal device. This is important in cases where the manufacturing time is significantly shorter than the removal time. By adapting the manufacturing time or slowing down the manufacturing of workpieces using the machining apparatus, the manufacturing quality of the workpieces can be increased. In addition, process reliability can be increased by reducing the machine's manufacturing speed. Furthermore, the machine can be operated in a lower consumption operating range, which can have a positive effect on electricity and/or water consumption, cooling and the use of other media. In an analogous manner, it can be provided that the removal time is adapted to a significantly longer manufacturing time. In this way, the process reliability when removing the workpieces from the removal area can be increased, removal errors can be prevented and the use of energy and/or media can be reduced.

In a preferred embodiment of the machine management method, it is provided that a downtime of the machining apparatus and/or a removal device is/are predetermined by the machine management system, wherein the machine management system changes the schedule by adding at least one unplanned activity during the downtime. A downtime preferably includes a duration of the downtime and a starting time at which the downtime occurs. In order to prevent the expected downtime, it is planned in this case that an additional activity is carried out by the machine and/or the operator during this time period. The unplanned activity can, for example, consist of the manufacturing of additional workpieces, which can further increase the productivity of the machine.

An unplanned activity represents an additional activity to be carried out by the machine and/or the operator that is not provided for in the predetermined schedule. Planned activities can also be added to the schedule in the form of an unplanned activity. Unplanned activities are typically cyclical functions that ensure that the machine can operate under optimal conditions.

Preferably, an unplanned activity can be added by the machine management system over several non-contiguous downtimes. For example, it can be provided that, in the case of an axis diagnosis of several machining axes of the machine, an individual diagnosis of one machining axis of the machine is carried out during a downtime. This can further improve productivity.

A further development of the machine management method is preferred in which the machine management system increases the downtime by temporally shifting, in particular by changing the process sequence or the sequence of the planned activities, of successive planned activities of the machining apparatus and/or the removal device in order to perform the at least one added unplanned activity. In other words, the planned activities are shifted so that two predetermined downtimes coincide into a common time period. This allows an unplanned activity that takes too long to be added to the schedule without causing a loss of manufacturing for a predetermined downtime. The time period for performing the unplanned activity may also overlap with planned activities of the machine that are not related in terms of process technology. For example, it can be provided that a diagnostic activity overlaps the time period of a pallet change activity, since the diagnosis is independent of the pallet change.

A preferred further development of the machine management method further provides for the unplanned activity to be added in the form of an activity which monitors and/or maintains the condition of the machine, in particular in the form of a diagnostic activity, a cleaning activity, a calibration activity and/or a lubrication activity. By means of a diagnostic activity in the form of an unplanned activity, an impending failure of the machine can be remedied at an early stage. Maintenance work can help prevent damage to the machine. This means that any required maintenance work can be carried out at the appropriate time without any loss of productivity. Long downtimes due to postponed condition-maintaining activities are avoided.

It may also be provided that subsequent production is carried out as a result of an unforeseen event within the context of an unplanned secondary activity. This can effectively prevent rescheduling of already established schedules.

In a preferred embodiment of the machine management method, the manufacturing process data and/or the removal process data are recorded during the operation of the machine and evaluated by the machine management system. This enables even more precise prediction of downtimes and flexible adaptation to possible faults that occur during machine operation.

In a further preferred embodiment of the machine management method, the manufacturing time of at least one further machine is determined by the machine management system on the basis of the manufacturing process data of the further machine, and the removal time of the further machine is determined by the machine management system on the basis of the removal process data of the further machine, and wherein the machine management system changes the schedules of the planned activities based on the determined manufacturing times and the determined removal times and transfers them to the controllers of the respective machines. In other words, the machine management system can be used for two or more machines, in particular a plurality of machines, at the same time. This can reduce the cost of the machine management system.

In a preferred development of the machine management method, the machine management system transfers at least one planned activity from the schedule of the machine into the schedule of the further machine as an unplanned activity, wherein at least one unplanned activity is added into the schedule of the machine instead of the transferred planned activity. This allows activities to be carried out across multiple machines. This enables the redistribution of activity during production peaks, in the event of machine malfunctions and/or the performance of urgent condition-maintaining activities. A loss of productivity can thus be reduced or completely prevented.

In a further preferred embodiment of the machine management method, the manufacturing time is determined based on a workpiece material, a workpiece thickness, a workpiece geometry, at least one manufacturing parameter of the machining apparatus when manufacturing a workpiece, a manufacturing time, a condition of a workpiece support, a position of a panel on a pallet changer, an error occurring during manufacturing and/or a manual interruption during manufacturing of a workpiece. In addition, the use of additional manufacturing process data may be provided. However, the manufacturing process data mentioned above have proven to be useful in predicting the manufacturing time.

In another preferred embodiment of the machine management method, the removal time is based on a workpiece material of a removed workpiece, a workpiece thickness of a removed workpiece, a number of removed workpieces, a number of different workpiece geometries of the removed workpieces, a workpiece geometry, a position of a panel on the pallet changer, a movement sequence of the removal device over the panel during the removal of workpieces and/or a number of workpiece removals. In addition, the use of additional removal process data may be provided. However, the previously mentioned removal process data have proven to be useful in predicting the removal time.

It is further preferable if the removal time can be based on a raw material, a dimension, in particular a thickness, of the raw material and/or a position of the raw material on the pallet changer. In addition, the use of additional loading process data may be provided. However, the loading process data mentioned above have proven to be useful in predicting the loading time. Preferably, a loading time for loading the machine with a raw material can be taken into account when comparing the manufacturing time with the removal time. The loading time can be partially or completely attributed to the removal time and/or the manufacturing time. The loading time may vary depending on the raw material, in particular the dimensions of the raw material. Preferably, the loading time, in particular the raw material, can be determined by means of an upcoming planned manufacturing of the workpiece by the machine. This allows downtime to be predicted even more precisely.

Further preferred is an embodiment of the machine management method in which the machine management system has a self-learning algorithm, in particular a neural network. This makes it possible to include a plurality of influencing factors or process data on the manufacturing and removal times to be determined in advance, which makes the prediction even more precise. In addition, the self-learning algorithm can be used to include a plurality of influencing factors or process data on a possible loading time. This can further improve the prediction accuracy.

The self-learning algorithm is preferably trained using a plurality of manufacturing process data and removal process data whose effect on a predetermined manufacturing time, a loading time and/or a predetermined removal time is known. In order to determine the impact of the process data on the manufacturing time, the loading time and/or the removal time, the predetermined schedule of the machine can be used as a basis, for example. In this case, the time theoretically required from the predetermined schedule can, for example, be compared with the actually measured time for an activity and the deviation can be evaluated as the effect of the influencing factors on the manufacturing time, the loading time and/or the removal time. Preferably, the process data are collected over a plurality of process cycles to improve the accuracy of the prediction. The process data can be provided manually by an operator or automatically by the machine. The process data is preferably transferred from a plurality of machines and/or operators by means of known data transmission to a central data storage device, which serves as the basis of the self-learning algorithm.

In a preferred embodiment of the machine management method, it is provided that the machine management method is adapted for implementation on a flatbed machine tool, in particular a laser beam cutting device or a punching device.

The underlying object is further achieved by a machine arrangement having at least one machine and a machine management system, wherein the machine has a machining apparatus which is designed to manufacture workpieces according to a predetermined schedule, wherein the machine management system is configured to carry out the machine management method described above.

Preferably, the machine has a removal device which is designed to sort workpieces from a removal area of the machine into a deposition area of the removal device. This can increase the degree of automation.

In a preferred embodiment of the machine arrangement, the machine is designed as a flatbed machine tool, in particular as a laser beam cutting device or as a punching device. The devices described above are suitable for performing the machine management method.

Further preferred is an embodiment of the machine arrangement in which the machine arrangement has two or more, in particular a plurality of machines. This can reduce the cost of the machine management system and increase the effectiveness of the machine management method.

According to embodiments of the invention, the features mentioned above and those yet to be explained further may be used in each case individually or together in any desired expedient combinations. The embodiments shown and described should not be understood as an exhaustive list.

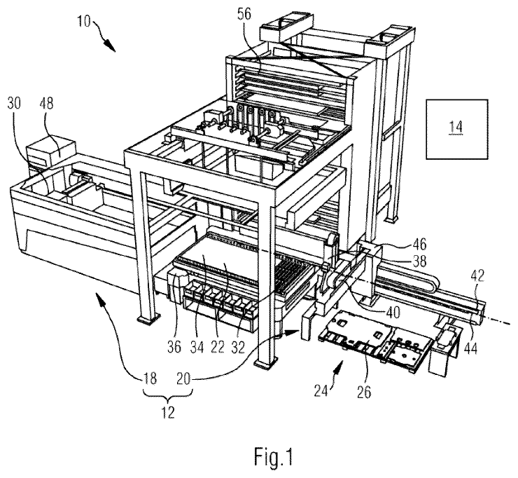

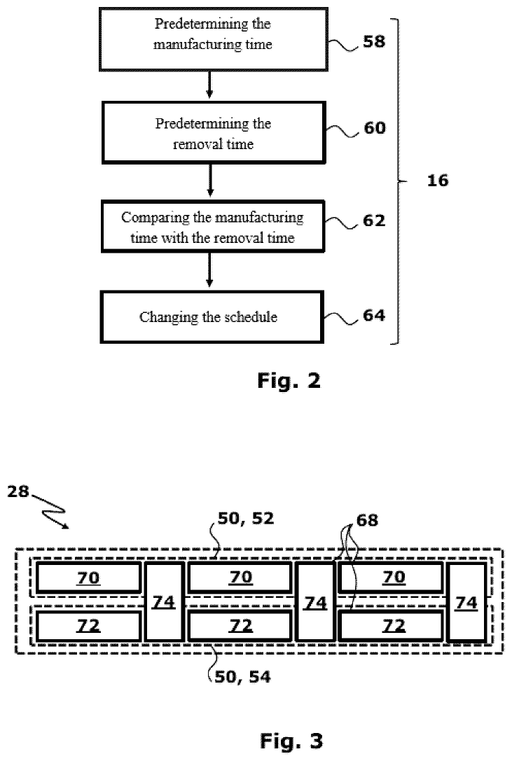

FIG. 1 shows a machine arrangement 10 having a machine 12 and a machine management system 14 to illustrate a machine management method according to embodiments of the invention 16 (see FIG. 2).

The machine 12—here a flatbed machine tool—has a machining apparatus 18 in the form of a laser cutting machine, a removal device 20, a removal area 22 of the machining apparatus 18 and a deposition area 24 of the removal device 20. The machine 12 shown in FIG. 1 is to be understood as an exemplary embodiment. The feature descriptions given here and below can be transferred, for example, to a punching machine.

The exemplary machining apparatus 18 is designed for manufacturing workpieces 26 according to a predetermined schedule 28 (see FIG. 3) (for reasons of clarity, only one workpiece 26 is provided with a reference symbol). To monitor the manufacturing of the workpieces 26, the flatbed machine tool 18 has a monitoring sensor system 30. The monitoring sensor system 30 can have several measuring means that are configured to measure various process variables during the manufacturing of the workpieces 26. For example, a workpiece material, a workpiece thickness, a workpiece geometry, the condition of a workpiece support 32 and/or a position of a panel 34 on a pallet changer 36 can be determined. In addition, it can be provided that these and other manufacturing process data such as a manufacturing time, manufacturing parameters stored for the manufacturing of the workpieces 26, errors occurring during manufacturing and/or manual interruptions of the machine 12, in particular the machining apparatus 18 and/or the removal device 20, are provided.

As shown in FIG. 1, the workpieces 26 previously manufactured in the machining apparatus 18 are positioned on the workpiece support 32 in the removal area 22. The workpiece support 32 has, for example, a web support as shown.

The exemplary removal device 20 has a gripper 38 which is movably arranged on a cantilever arm 40 and can be moved by means of a rail guide 42 along an axis 44 between the removal area 22 and the deposition area 24. The gripper 38 can be moved translationally and rotationally relative to the cantilever arm 40.

The sorting of the workpieces 26 is predetermined in the schedule 28 and is carried out by the gripper 38, which is moved by a removal controller 46 of the removal device 20 until the workpieces 26 are removed from the removal area 22 and placed in the deposition area 24. The gripper 38 moves, for example, along the axis 44 over the removal area 22 and is deflected in a vertical direction up to the workpieces 26. The gripper 38 then grips one of the workpieces 26, for example, and is then moved upwards in a vertical direction. The gripper 38 is then moved along the axis 44 into the deposition area 24 and deflected there in the same way in order to deposit the picked-up workpiece 26.

The machine management system 14 is designed as an independent component, as shown in FIG. 1. It can also be provided that the machine management system 14 is integrated into the machine 12, in particular into the removal controller 46 and/or into a machining controller 48 of the machining apparatus 18. In any case, the machine management system 14 is configured and designed to communicate with the machine 12. In a preferred embodiment, the machine management system 14 forms a central controller of the machine 12, in particular of the machining apparatus 18 and the removal device 20.

The predetermined schedule 28 can be stored for the entire machine 10 or can provide partial schedules. For example, a partial schedule 50 (see FIG. 3) can be provided as a manufacturing plan 52 (see FIG. 3) and stored in the machining controller 48 of the machining apparatus 18 and a further partial schedule 50 can be provided as a removal schedule 54 (see FIG. 3) and stored in the removal controller 46 of the removal device 20.

A typical method for manufacturing and removing the workpieces 26 by the machine 12 can provide a schedule 28 in which the workpieces 26 located on a pallet are manufactured according to the schedule within the machining apparatus 18, while workpieces 26 located on another pallet that have already been manufactured are systematically sorted by the removal device 20. In other words, the manufacture and removal of the workpieces 26 can take place at the same time or parallel to each other. Once the planned activities of the machine 12 have been completed, the completely removed pallet can be stowed in a magazine 56. The pallet with manufactured workpieces 26 can then take up the position in the removal area 22 of the machining apparatus 18 via the pallet changer 36, and a further pallet with workpieces 26 to be manufactured from a panel 34 is fed to the machining apparatus 18. Such a method has high manufacturing rates.

In addition to the automatic removal by the removal device 20 shown in FIG. 1, it can also be provided that a planned sorting of manufactured workpieces 26 is carried out manually by an operator of the machine 12. A removal device 20 can be omitted.

FIG. 2 shows an exemplary sequence of the machine management method 16 according to embodiments of the invention in a schematic representation.

According to a method step 58, a manufacturing time for manufacturing the workpieces 26 (see FIG. 1) by the machining apparatus 18 (see FIG. 1) is predetermined. For this purpose, manufacturing process data is provided, on the basis of which the machine management system 14 determines or calculates the manufacturing time. In other words, an actual manufacturing time for the removal of the workpieces 26 can be determined, which may deviate from a manufacturing time assumed in the predetermined schedule 28. The predetermined manufacturing time may include a forecast of the start of manufacturing, the end of manufacturing and/or the duration of manufacturing.

In a further method step 60, a removal time for removing the workpieces 26 by the removal device 20 (see FIG. 1) is predetermined. For this purpose, removal process data is provided, on the basis of which the machine management system 14 determines or calculates the removal time. In other words, an actual removal time for the removal of the workpieces 26 can be determined, which may deviate from a removal time assumed in the predetermined schedule 28 (see FIG. 3). The predetermined removal time may include a forecast of the start of the removal, the end of the removal and/or the duration of the removal.

The predetermined removal time and the predetermined manufacturing time make it possible to take into account influences such as disturbances and/or deviations in the machining or removal speeds during machine operation that were not known before the start of manufacturing or removal.

The order of the method steps 58, 60 is to be understood as exemplary and can, for example, be swapped. Furthermore, it can be provided that the method steps 58, 60 are carried out at the same time.

The predetermination of the manufacturing time and the removal time according to the method steps 58, 60 is followed by a method step 62 in which the predetermined manufacturing time is compared with the predetermined removal time. Deviations from the predetermined schedule 28 can thus be detected.

In a further method step 64, it is then provided that the predetermined schedule 28 is changed by the machine management system 14. For this purpose, the machine management system 14 can, for example, directly access the stored schedule 28 and modify it during operation by the machine 12, in particular automatically. Another embodiment provides that a change in the predetermined schedule 28 only takes place after approval by the operator of the machine 12.

It can also be provided that the machine management system 14 creates a changed schedule 66 (see FIG. 5). This can then be stored in the machine 12, in particular automatically, for example by the machine management system 14. Furthermore, it can be provided that the changed schedule 66 must first be confirmed by the operator of the machine 12.

FIG. 3 shows an exemplary predetermined schedule 28 for a machine 12 with two partial schedules 50. The schedule 28, or the partial schedules 50, show planned activities 68. The first partial schedule 50 is designed as a manufacturing schedule 52 and the second partial schedule 50 is designed as a removal schedule 54. The manufacturing schedule 52 shows three manufacturing activities 70. The manufacturing activities 70 each begin, for example, with the manufacturing of a first workpiece 26 of a panel 34 newly fed to the machining apparatus 18 and end with the manufacturing of a last workpiece 26 from this panel 34.

The removal schedule 54 has three removal activities 72. The removal activities 72 each begin, for example, with the removal of a first manufactured workpiece 26 and end with the removal of the last workpiece 26 located in the removal area 22.

The manufacturing activities 70 and the removal activities 72 are planned in chronological order according to the schedule 28 shown and are each separated by pallet changing activities 74. The pallet changing activities 74 each have the steps of stowing a sorted pallet in the magazine 56 (see FIG. 1), positioning a pallet with finished workpieces 26 in the removal area 22 and feeding a new panel 34 into the machining apparatus 18.

The manufacturing times of the manufacturing activities 70 are coordinated with the removal times of the removal activities 72 according to the schedule 28 shown. In other words, the predetermined schedule 28 represents an ideal course of manufacturing and removal.

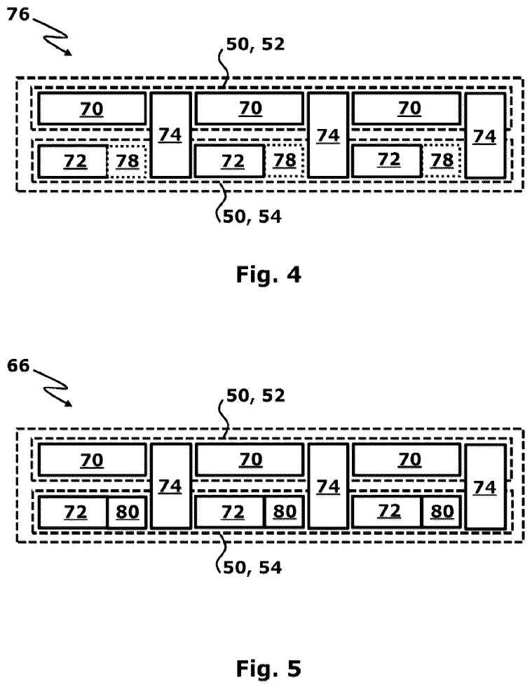

FIG. 4 shows an exemplary actual sequence 76 of the manufacturing and removal of workpieces 26, with the partial schedule 50 designed as a manufacturing schedule 52 and the second partial schedule 50 designed as a removal schedule 54. The removal activities 72 and the manufacturing activities 70 are each separated from each other by a pallet changing activity 74.

The removal activities 72 have a removal time that is significantly shorter than the manufacturing time of the manufacturing activities 70. The shortened removal time can be predetermined by the machine management system 14 (see FIG. 1) and a downtime 78 with the time and duration of the downtime 78 can be determined.

The predetermined schedule 28 can then be changed by the machine management system 14. For example, the manufacturing speed of the machining apparatus 18 can be increased, whereby a larger number of workpieces 26 can be produced by the machine 12.

In another actual sequence 76, however, it may happen that the manufacturing time is significantly shortened compared to the removal time. In this case, it may be provided, for example, to reduce the manufacturing speed of the machining apparatus 18, whereby a higher manufacturing quality of the workpieces 26 can be achieved.

FIG. 5 shows the schedule 66 changed by the machine management system 14 on the basis of the actual procedure 76 shown in FIG. 4. The machine management system 14 assigns an unplanned activity to the removal schedule 54 80 during the downtime period 78 (see FIG. 4). The unplanned activity 80 may, for example, take the form of a maintenance activity, a cleaning activity, a calibration activity and/or a diagnostic activity.

The unplanned activity 80 can be spread over several downtimes 78. Furthermore, another unplanned activity may be scheduled during each downtime 78.

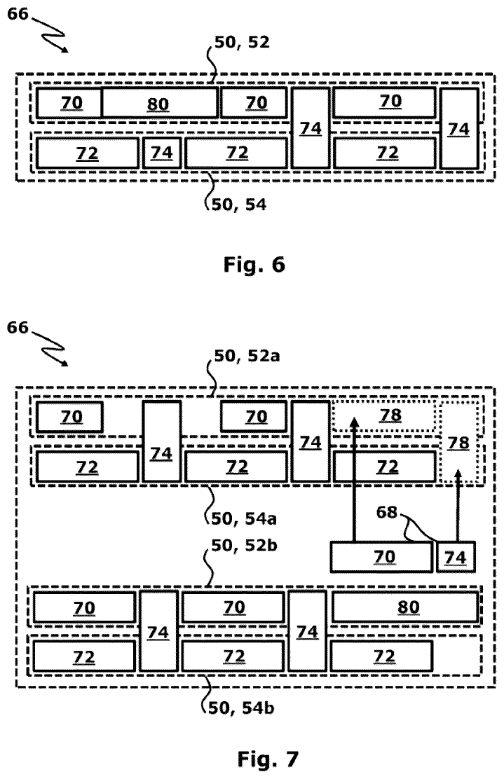

FIG. 6 shows another example of a changed schedule 66, which is based on a significantly shortened manufacturing time for the manufacturing activity 70 compared to the removal time for the removal activity 72.

The removal activities 72 of the removal schedule 54 are unchanged compared to a predetermined schedule 28. The manufacturing schedule 52 has been changed so that the start of the second manufacturing activity 70 occurs later than planned. This results in an extended time period of time between the first and second manufacturing activities 70, which is available for performing a more time-intensive unplanned activity 80. The unplanned activity 80 can be selected such that the pallet changing activity 74 can be carried out unaffected.

FIG. 7 shows a further exemplary changed schedule 66 with four partial schedules 50, wherein a manufacturing schedule 52a and a removal schedule 54a and a manufacturing schedule 52b and a removal schedule 54b are carried out on different machines 12.

The machine management system 14 can predetermine downtimes 78 in the manufacturing schedule 52a, as shown in FIG. 7. The predetermined downtimes 78 can be used to transfer activities 68—here a manufacturing activity 70 and a pallet changing activity 74. This can create a time period for performing an unplanned activity 80 in the manufacturing process 52b. This is advantageous, as any required maintenance, calibration, diagnosis and/or cleaning can be carried out without any downtime.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

Machine arrangement 10;
Machine 12;
Machine management system 14;
Machine management method 16;
Machining apparatus 18;
Removal device 20;
Removal area 22 of the machine 12;
Deposition area 24 of the removal device 20;
Workpiece 26;
Schedule 28;
Monitoring sensor system 30;
Workpiece support 32;
Panel 34;
Pallet changer 36;
Gripper 38;
Cantilever arm 40;
Rail guide 42;
Axis 44;
Removal controller 46 of the removal device 14;
Machining controller 48 the machining apparatus 18;
Partial schedule 50 of the schedule 28;
Manufacturing schedule 52, 52a, 52b;
Removal schedule 54, 54a, 54b;
Magazine 56;
Method step 58, 60, 62, 64;
Changed schedule 66;
Planned activity 68;
Manufacturing activity 70;
Removal activity 72;
Pallet changing activity 74;
Actual sequence 76;
Downtime 78;
Unplanned activity 80.

1. A machine management method for performing planned activities on a machine, wherein workpieces are manufactured by the machine according to a predetermined schedule during a respective planned activity of the machine, and manufactured workpieces are sorted from a removal area of the machine into a deposition area during a further respective planned activity of the machine according to the predetermined schedule, the method comprising:
determining a manufacturing time for the workpieces by a machine management system based on manufacturing process data of the machine,
determining a removal time for sorting the workpieces by the machine management system based on removal process data,
changing the predetermined schedule to obtain a changed schedule for the planned activities by the machine management system based on a comparison of the manufacturing time with the removal time, and
transferring the changed schedule to a controller of the machine.

2. The machine management method according to claim 1, wherein manufacturing of the workpieces by the machine takes place at a same time as removal of the manufactured workpieces.

3. The machine management method according to claim 2, wherein the predetermined schedule is changed by adapting the manufacturing time of the machining apparatus to the removal time.

4. The machine management method according to claim 1, further comprising determining a downtime of the machine and/or a removal device by the machine management system, wherein the machine management system changes the predetermined schedule by adding at least one unplanned activity during the downtime.

5. The machine management method according to claim 4, wherein the machine management system increases the downtime by temporally shifting successive planned activities of the machine and/or the removal device for performing the at least one added unplanned activity.

6. The machine management method according to claim 4, wherein the unplanned activity comprises monitoring and/or maintaining a condition of the machine.

7. The machine management method according to claim 4, wherein the unplanned activity comprises a diagnostic activity, a cleaning activity, a calibration activity, and/or a lubrication activity.

8. The machine management method according claim 1, wherein the manufacturing process data and/or the removal process data are recorded during operation of the machine and evaluated by the machine management system.

9. The machine management method according claim 1, further comprising determining a manufacturing time of at least one further machine by the machine management system based on manufacturing process data of the further machine, and determining a removal time of the further machine by the machine management system based on removal process data of the further machine, and wherein the machine management system changes the schedules of the planned activities based on the manufacturing times and the removal times, and transfers the schedules to the controllers of the respective machines.

10. The machine management method according to claim 9, wherein the machine management system transfers at least one planned activity from the schedule of the machine into the schedule of the further machine as an unplanned activity, and wherein at least one further unplanned activity is added into the schedule of the machine instead of the transferred planned activity.

11. The machine management method according claim 1, wherein the manufacturing time is determined based on a workpiece material, a workpiece thickness, a workpiece geometry, manufacturing parameters of the machine when manufacturing the workpieces, a condition of a workpiece support, a position of a panel on a pallet changer, an error occurring during manufacturing, and/or a manual interruption during the manufacturing of the workpieces.

12. The machine management method according claim 1, wherein the removal time is determined based on a workpiece material of the removed workpiece, a workpiece thickness of the removed workpiece, a number of removed workpieces, a number of different workpiece geometries of the removed workpieces, a workpiece geometry, a position of a panel on a pallet changer, a movement sequence of a removal device over the panel during removal of the workpieces, and/or a number of workpiece removals.

13. The machine management method according claim 1, wherein the machine management system has a self-learning algorithm.

14. The machine management system according to claim 13, wherein the self-learning algorithm comprises a neural network.

15. The machine management method according claim 1, wherein the machine management method is adapted for implementation on a flatbed machine tool.

16. A machine arrangement comprising at least one machine and a machine management system, wherein the machine is configured to manufacture workpieces according to a predetermined schedule, wherein the machine management system is configured to carry out the machine management method according claim 1.

17. The machine arrangement according to claim 16, wherein the machine is configured as a flatbed machine tool.

18. The machine arrangement according to claim 16, comprising a plurality of machines.
